(19) United States
(12) Patent Application Publication
(10) Pub. No.: US 2026/0338377 A1
(43) Pub. Date: Oct. 29, 2026

(54) PREMIXING APPARATUS

(71) Applicant: RINNAI CORPORATION, Aichi (JP)

(72) Inventors: Takahiro OINE, Aichi (JP); Kotaro KUZUYA, Aichi (JP); Yoshimasa TSUNEKAWA, Aichi (JP)

(73) Assignee: RINNAI CORPORATION, Aichi (JP)

(21) Appl. No.: 19/491,097

(22) PCT Filed: Apr. 1, 2024
(86) PCT No.: PCT/JP2024/013426

§ 371 Date: Dec. 8, 2025

(30) Foreign Application Priority Data
Jul. 3, 2023 (JP) 2023-109610

(51) Int. Cl. F23N 1/02

(52) U.S. Cl. CPC F23N 1/022; F23N 2231/10

(57) ABSTRACT

In a premixing apparatus, a zero governor is arranged in a gas supply passage, and a variable throttle valve is driven by a stepping motor. A detecting device is provided to detect movements of the valve body of the variable throttle valve. The detecting device is configured to switch ON when the valve body enters a first stroke range in a closed side, and to switch OFF when the valve body enters a second stroke range in an open side. By moving the valve body to the stroke end position in the closed direction and performing homing, the valve body is then moved in the open direction. During this movement, when the step number of the stepping motor at the switching of the detecting device from ON to OFF deviates from a reference step number required for movement from the homing position to the second stroke range by a predetermined value, an abnormality is determined.

### TECHNICAL FIELD

The invention relates to a premixing apparatus that mixes fuel gas with air and supplies an air-fuel mixture to a burner via a fan.

### BACKGROUND ART

Conventionally, as a premixing apparatus of this kind, there has been known the apparatus disclosed in Patent Document 1, which includes: a zero governor for regulating a secondary gas pressure to atmospheric pressure, the zero governor being interposed in a gas supply passage, of which a downstream end is connected to a gas suction part disposed in a portion of an air supply passage located on an upstream side of the fan; a variable throttle valve interposed in a portion of the gas supply passage located on a downstream side of the zero governor and driven by a stepping motor; and a controlling device for controlling the fan and the variable throttle valve. Here, the supply amount of fuel gas varies in accordance with a differential pressure between atmospheric pressure, serving as the secondary gas pressure, and a negative pressure acting on the gas suction part. Since the negative pressure acting on the gas suction part varies with a fan speed, the supply amount of the fuel gas changes in proportion to the fan speed, i.e., the supply amount of air. In addition, a ratio of the supply amount of the fuel gas to the supply amount of air changes due to an opening degree of the variable throttle valve. Accordingly, the opening degree of the variable throttle valve is set to a predetermined standard opening degree in accordance with the type of gas to be used, so that an excess ratio of the air-fuel mixture becomes a predetermined appropriate value.

In addition, in the premixing apparatus disclosed in Patent Document 1, a detecting device for detecting movements of a valve body of the variable throttle valve is additionally provided with the variable throttle valve. The detecting device has a detecting switch. The detecting switch is configured to be turned on when the valve body of the variable throttle valve moves in a closed direction and thereby enters a first stroke range between a predetermined first position and a stroke end position in the closed direction. The detecting switch is also configured to be turned off when the valve body of the variable throttle valve moves in an open direction and thereby enters a second stroke range between a predetermined second position, which is displaced in the open direction from the first position, and a stroke end position in the open direction. The controlling device is configured to, first, perform a first operation in which the valve body is caused to move to the stroke end position in the closed direction, thereby carrying out homing of the stepping motor during a pre-purge operation before ignition of the burner, in which the fan is caused to drive without supply of the fuel gas, and, then, an abnormality is determined if the detecting switch has not been turned on at the time of completion of the first operation. The controlling device is also configured to perform a second operation, if the detecting switch has been turned on, in which the valve body of the variable throttle valve is caused to move in the open direction to a predetermined position within the second stroke range, and an abnormality is determined if the detecting switch has not been turned off at the time of completion of the second operation. Thus, the controlling device is configured to perform an ignition control only when the detecting switch is turned off.

However, in these configurations, it cannot be said that precision of failure detection of the variable throttle valve is sufficient. Here, during out-of-operation without driving the fan, it is unnecessary to reduce waiting time to ignition, unlike during the pre-purge operation. Then, it is desired that the failure of the variable throttle valve can be precisely detected during out-of-operation.

### PRIOR ART

### Patent Document

Patent Document 1: JP2022-150178A

### SUMMARY OF INVENTION

### Problem that the Invention is to be Solved

The invention has been made in view of the above points and addresses the problem of providing a premixing apparatus in which the failure of the variable throttle valve can be detected with high accuracy during out-of-operation in which the fan is not driven.

### MEANS FOR SOLVING THE PROBLEM

In order to solve the problem described above, the invention provides a premixing apparatus that mixes fuel gas with air and supplies an air-fuel mixture to a burner via a fan, comprising: a zero governor for regulating a secondary gas pressure to atmospheric pressure, the zero governor being interposed in a gas supply passage, of which a downstream end is connected to a gas suction part disposed in a portion of an air supply passage located on an upstream side of the fan; a variable throttle valve interposed in a portion of the gas supply passage located on a downstream side of the zero governor and driven by a stepping motor; and a controlling device for controlling the fan and the variable throttle valve, wherein a detecting device for detecting movements of a valve body of the variable throttle valve is additionally provided with the variable throttle valve, and the detecting device has a detecting switch that turns on when the valve body of the variable throttle valve moves in a closed direction and thereby enters a first stroke range between a predetermined first position and a stroke end position in the closed direction, and turns off when the valve body of the variable throttle valve moves in an open direction and thereby enters a second stroke range between a predetermined second position, which is displaced in the open direction from the first position, and a stroke end position in the open direction, wherein: the controlling device is configured to perform a first control in which, during out-of-operation in which the fan is not driven, a first operation and a second operation are carried out sequentially: the first operation in which the valve body is caused to move to the stroke end position in the closed direction, thereby carrying out homing of the stepping motor; and the second operation in which the valve body of the variable throttle valve is caused to move in the open direction to a predetermined position within the second stroke range, and an abnormality is determined when, during the second operation, a step number of the stepping motor at the time of switching of the detecting switch from ON to OFF deviates from a reference step number required for movement from a home position to the second position by a predetermined value or more. It should be noted that, in the invention, the step number of the stepping motor refers to a counted value, provided that the home position, a rotational step number in the open direction of the valve body of the variable throttle valve, and a rotational step number in the closed direction of the valve body of the variable throttle valve are defined as zero, a positive number, and a negative number, respectively.

According to the invention, when a failure occurs in which the valve body of the variable throttle valve is locked before reaching the stroke end position in the closed direction, the failure can be detected. That is, if, during the first operation, the valve body of the variable throttle valve is locked before reaching the stroke end position in the closed direction, homing of the stepping motor is carried out at this locked position. Therefore, during the second operation, the step number of the stepping motor at the time of switching of the detecting switch from ON to OFF becomes a value different from the reference number required for the movement from the homing position to the second position. Accordingly, in the invention, when the failure occurs in which the valve body of the variable throttle valve is locked before reaching the stroke end position in the closed direction, an abnormality is determined. As a result, the failure can be detected.

In addition, in the invention, it is desirable that the controlling device is configured to perform a second control in which, during out-of-operation, a third operation, a fourth operation, and a fifth operation are carried out sequentially: the third operation in which the valve body of the variable throttle valve is caused to move in the closed direction until the detecting switch switches from OFF to ON; the fourth operation in which the valve body of the variable throttle valve is caused to move in the open direction until the stroke end position in the open direction; and the fifth operation in which the valve body of the variable throttle valve is caused to move in the closed direction until the detecting switch switches from OFF to ON, and an abnormality is determined when a difference between the step number of the stepping motor at the time of completion of the third operation and the step number of the stepping motor at the time of completion of the fifth operation is a predetermined value or more. According to this, when a failure occurs in which the valve body of the variable throttle valve is locked before reaching the stroke end position in the open direction, such a failure can be detected. That is, when the valve body of the variable throttle valve, during the fourth operation, is locked before reaching the stroke end position in the open direction, thereafter, although the valve body does not move in the open direction, the step numbers of the stepping motor are accumulated until it is determined by the control logic that the valve body has reached the stroke end position in the open direction and the fourth operation is completed. As a result, the step number of the stepping motor at the time of completion of the fifth operation becomes larger than the step number of the stepping motor at the time of completion of the third operation by the step numbers accumulated after the valve body is locked during the fourth operation. Accordingly, by means of the second control mentioned above, when the failure occurs in which the valve body of the variable throttle valve is locked before reaching the stroke end position in the open direction, an abnormality is determined, and thereby such a failure can be detected.

Furthermore, in the invention, it is desirable that the controlling device is configured to perform a third control in which an abnormality is determined when the detecting switch is OFF at completion of the first operation, and when, although at least one of the third operation and the fifth operation is continued for a predetermined time, the detecting switch does not switch from OFF to ON. According to this, when a movement failure in the closed direction of the valve body of the variable throttle valve occurs, an abnormality is determined, and thereby such a failure can be detected.

In addition, in the invention, it is desirable that the controlling device is configured to perform a fourth control in which an abnormality is determined when the detecting switch is ON at least at one of the time of completion of the second operation and the time of completion of the fourth operation. According to this, when a movement failure in the open direction of the valve of the variable throttle valve occurs, an abnormality is determined, and thereby such a failure can be detected.

### BRIEF DESCRIPTION OF THE DRAWINGS

FIG. 1 is an explanatory diagram showing a premixing apparatus according to an embodiment of the invention.

FIG. 2 is a cross-sectional view taken along II-II line of FIG. 1.

FIG. 3 is a cross-sectional view of a main part of the variable throttle valve included the premixing apparatus according to the embodiment.

FIG. 4 FIG. 4 is a flow chart showing a failure detecting control of the variable throttle valve, carried out by a controlling device in the premixing apparatus according to the embodiment.

### MODES FOR CARRYING OUT THE INVENTION

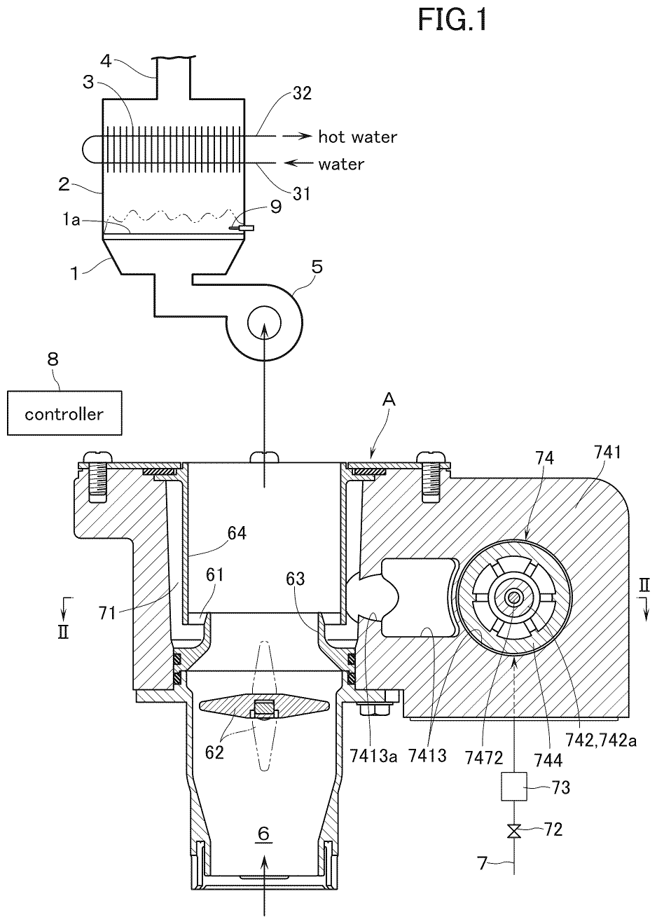

A combustion apparatus illustrated in FIG. 1 is a heat source machine provided with a totally primary-aerated burner 1, a combustion box 2 surrounding a combustion space of an air-fuel mixture to be ejected from a combustion surface la of the burner 1, and a heat exchanger 3 disposed within the combustion box 2. A combustion gas generated by combustion of the air-fuel mixture transfers heat to the heat exchanger 3 and is subsequently exhausted through an exhaustion pipe 4 connected to one end of the combustion box 2. By means of a premixing apparatus A according to an embodiment of the invention, a fuel gas is mixed with air, and the resulting air-fuel mixture is supplied to the burner 1 through a fan 5.

The premixing apparatus A is provided with an air supply passage 6 located on an upstream side of the fan 5, a gas supply passage 7 for supplying the fuel gas, and a controller 8 serving as a controlling device. A downstream end of the gas supply passage 7 is connected to a gas suction part 61 disposed in the air supply passage 6. In a portion of the air supply passage 6 adjacent to the upstream side of the gas suction part 61, a venturi part 63 having a smaller diameter than a portion where the butterfly valve 62 mentioned below is disposed is provided. A portion of the air supply passage 6 adjacent to the downstream side of the venturi part 63 is surrounded by a cylindrical part 64 having a larger diameter than that of the venturi part 63. Furthermore, a downstream end portion of the venturi part 63 is inserted into an upstream end portion of the cylindrical part 64 via an annular clearance, which defines the gas suction part 61. A gas chamber 71 communicating with the gas suction part 61 is provided at a downstream end of the gas supply passage 7 so as to surround the cylindrical part 64. In addition, a master valve 72, a zero governor 73 that regulates a secondary pressure to atmospheric pressure, and a variable throttle valve 74 are sequentially interposed from the upstream side in the gas supply passage 7.

The amount of fuel gas supplied through the gas suction part 61 varies in accordance with a differential pressure between the atmospheric pressure, serving as the secondary pressure, and a negative pressure acting on the gas suction part 61. Here, the negative pressure acting on the gas suction part 61 varies depending on the rotational speed of the fan 5. Therefore, the amount of fuel gas supplied is proportional to the rotational speed of the fan 5, that is, to the amount of air supplied. In addition, a ratio between the amounts of fuel gas and air supplied changes depending on an opening degree of the variable throttle valve 74. An air excess ratio of the air-fuel mixture is set to a predetermined appropriate value (for example, 1.3) by adjusting the opening degree of the variable throttle valve 74 to a predetermined standard opening degree corresponding to the type of gas to be used. Furthermore, the air-fuel mixture having the appropriate air excess ratio and an amount corresponding to the required combustion amount (i.e., the combustion amount necessary to discharge hot water at a set temperature) is supplied to the burner 1 by controlling the rotational speed of the fan 5 in accordance with the required combustion amount.

It should be noted that, in order to prevent poor exhaustion due to intrusion of wind into the exhaust pipe 4, that is, to ensure wind-resistant property, a lower limit of the rotational speed of the fan 5 cannot be set too low. When the required combustion amount is smaller than a predetermined value corresponding to the lower limit of the rotational speed of the fan 5, the amount of air corresponding to the required combustion amount cannot be supplied.

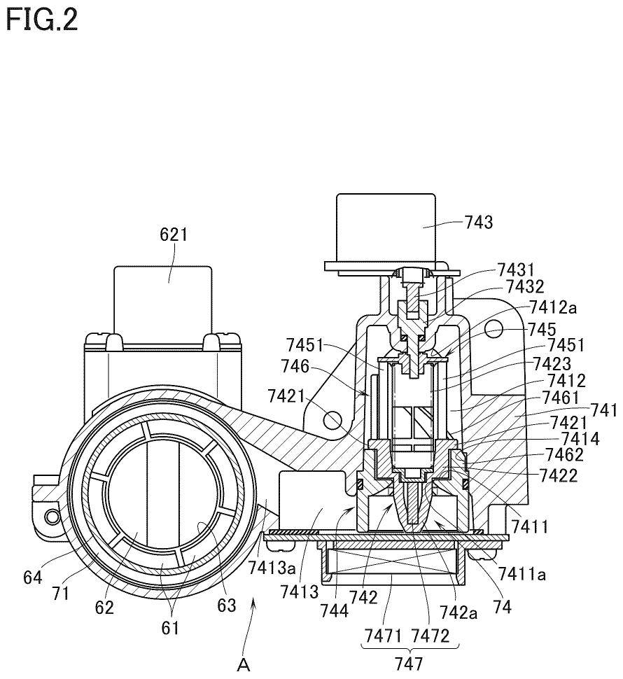

Therefore, in order to switch the ventilation resistance of that portion between two stages: large and small, the butterfly valve 62 is disposed in a portion of the air supply passage 6 located on the upstream side of the gas suction part 61. The butterfly valve 62 is switched to a closed position, shown by a solid line in FIG. 1, and an open position, shown by a dotted line in FIG. 1, by a motor 621 (referred to in FIG. 2). Then, when the required combustion amount is smaller than the predetermined value mentioned above, the butterfly valve 62 is brought to the closed position to increase the ventilation resistance of the air supply passage 6. This enables the amount of air corresponding to the combustion amount smaller than the predetermined value to be supplied without lowering the rotational speed of the fan 5 below the lower limit of the rotational speed.

It should be noted that, when the butterfly valve 62 is in the closed position, since only the ventilation resistance of the air supply passage 6 increases, the negative pressure acting on the gas suction part 61 increases, thereby causing the supply amount of the fuel gas to be excessively large, as a result, air excess ratio of the fuel-gas mixture supplied to the burner 1 is lower than the appropriate value. Therefore, when the required combustion amount is relatively small, the butterfly valve 62 is brought into the closed position, and in addition, the opening degree of the variable throttle valve 74 is set to a small-capacity opening degree which is predetermined and relatively small, so that the air excess ratio of the air-fuel mixture becomes the appropriate value in the state where the butterfly valve 62 is in the closed position, whereby the combustion capacity switches to a small capacity. Accordingly, the amount of the air-fuel mixture, having the appropriate air excess ratio and corresponding to the relatively small combustion amount, is supplied to the burner 1. In addition, when the required combustion amount is relatively large, the butterfly valve 62 is brought into the open position, and in addition, the opening degree of the variable throttle valve 74 is set to a large-capacity opening degree serving as the standard opening degree so that the air excess ratio of the air-fuel mixture becomes the appropriate value in the state where the butterfly valve 62 is in the open position, whereby the combustion capacity switches to a large capacity. Accordingly, the amount of the air-fuel mixture, having the appropriate air excess ratio and corresponding to the relatively large combustion amount, is supplied to the burner 1.

Meanwhile, although the same kind of gas as the fuel gas is used, the heat generation mount (Wobbe index) of the fuel gas sometimes varies over time. In this case, if a ratio of the supply amount of the fuel gas to the supply amount of air is kept constant, the air excess ratio of the gas mixture varies due to the heat generation amount of the fuel gas, thereby causing poor combustion.

Then, an air-excess-ratio detecting device 9 for detecting the air excess ratio of the air-fuel mixture is provided. In the embodiment, the air-excess-ratio detecting device 9 is formed by a flame rod facing the combustion surface la of the burner 1 so that the air excess ratio of the air-fuel mixture is detected based on a flame current flowing through the flame rod. It should be noted that, since a flame comes close to and goes away from the combustion surface 1a corresponding to the air excess ratio of the air-fuel mixture, a rear-surface temperature changes in accordance with the air excess ratio of the air-fuel mixture. Accordingly, the air-excess-ratio detecting device 9 may be formed by a temperature sensor for detecting the rear-surface temperature of the combustion surface 1a.

The controller 8 performs a feedback control that regulates an opening degree of the variable throttle valve 74 so that the air excess ratio of the air-fuel mixture detected by the air-excess-ratio detecting device 9 is kept constant, that is, the air excess ratio is kept at a predetermined appropriate value. Specifically, when the air excess ratio is decreased by an increase of the heat generation amount of the fuel gas, the opening degree of the variable throttle valve is caused to decrease, and thereby the ratio of the supply amount of the fuel gas to the supply amount of air is caused to decrease so that the air excess ratio becomes the appropriate value. On the other hand, when the air excess ratio is increased by a decrease of the heat generation amount of the fuel gas, the opening degree of the variable throttle valve is caused to increase, and thereby the ratio of the supply amount of the fuel gas to the supply amount of air is caused to increase so that the air excess ratio becomes the appropriate value. According to this, even if the heat generation amount of the fuel gas varies, the air excess ratio of the air-fuel mixture is kept at the appropriate value, and thereby the poor combustion is prevented from occurring.

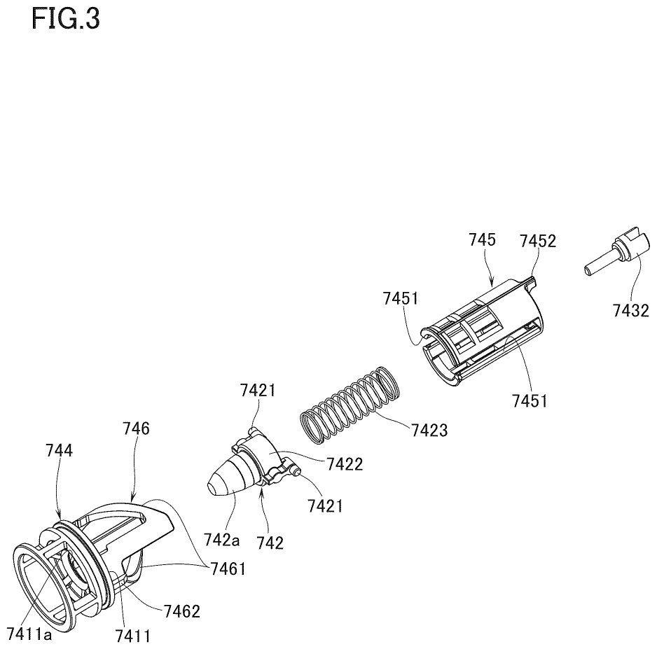

Next, a structure of the variable throttle valve 74 is described as follows. With reference to FIGS. 2, 3, the variable throttle valve 74 is an electrically-driven type, and includes a valve body 742 that comes close to and goes away from a valve seat 7411 in a valve box 741 in an axial direction, a stepping motor 743, and a motion conversion mechanism that causes the valve body 742 to move in the axial direction by rotation of the stepping motor 743. In the valve box 741, a primary-side gas chamber 7412, having a gas inlet hole 7412a, and a secondary-side gas chamber 7413, having a gas outlet hole 7413a communicating with the gas chamber 71 mentioned above, are provided. In addition, a member 744, in which the valve seat 7411 partitioning the primary-side gas chamber 7412 and the secondary-side gas chamber 7413 is formed, is mounted on the secondary-side gas chamber 7413.

The motion conversion mechanism includes a cam pin 7421 fixed to the valve body 742, a guide cylinder 745 provided with an axially extending elongated hole 7451 with which the cam pin 7421 is slidably engaged, and a cylindrical cam body 746 having a helical cam part 7461 with which the cam pin 7421 engages through the elongated hole 7451. A non-circular shaft part, when viewed in a cross-section, of a link member 7432 connected to an output shaft 7431 of the stepping motor 743 is caused to engage with an end part of the guide cylinder 745, so that the guide cylinder 745 rotates by rotations of the stepping motor 743.

In addition, the valve body 742 has a needle part 742a capable of inserting into a valve hole 7411a formed in the valve seat 7411, and a cylindrical part 7422 inserted into the guide cylinder 745. On an end portion of this cylinder part 7422, the cam pin 7421 is provided so as to protrude outward in a radial direction. A base end part of the cam pin 7421 is slidably engaged with the elongated hole 7451 formed in the guide cylinder 745. Thus, the valve body 742 is movable in the axial direction and connected to the guide cylinder 745 so as to rotate together with the guide cylinder 745.

The cam body 746 is locked against rotation to the valve box 741. Specifically, by causing a lib 7462 protruding on an outer circumferential surface of the cam body 746 to engage with a groove 7414 formed in an inner circumferential surface of the valve box 741, the cam body 746 is locked against rotation to the valve box 741. In order to reduce the number of components, the cam body 746 is integrally formed with the member 744 in which the valve seat 7411 is formed. The cam part 7461 is formed by a helical sloping edge with which the cam pin 7421 is capable of coming into contact. Due to forward and reverse rotation, the cam pin 7421 moves from one side to the other side in the axial direction while rotating and being guided along the cam part 7461, whereby the valve body 742 moves both in a closing direction, in which the valve body 742 comes close to the valve seat 7411, and in an open direction, in which the valve body 742 goes away from the valve seat 7411. It should be noted that the valve body 742 is movable between a stroke end position in the closed direction and a stroke end position in the open direction. At the stroke end position in the closed direction, the valve body 742 contacts the valve seat 7411. At the stroke end position in the open direction, a projection 7452b protruding from a distal end of the guide cylinder 745 contacts a stopper part (not shown) provided in the valve box 741, thereby preventing further reverse rotation (i.e., rotation in a direction in which the valve body 742 is moved in the open direction) of the guide cylinder 745.

In addition, a detecting device 747 for detecting the movements of the valve body 742 of the variable throttle valve 74 is additionally provided with the variable throttle valve 74. The detecting device 747 is formed by a detecting switch 7471 consisting of a reed switch provided at a position facing the needle part 742a on an outer surface of the secondary-side gas chamber 7413, and a magnet 7472 housed in the needle part 742a. The detecting switch 7471 is turned on due to receipt of a magnetic force from the magnet 7472 when the valve body 742 of the variable throttle valve 74 moves in the closed direction to enter a first stoke range between a predetermined first position and the stroke end position in the closed direction. On the other hand, the detecting switch 7471 is turned off when the valve body 742 moves in the open direction to enter a second stroke range between a predetermined second position, displaced in the open direction from the first position, and the stroke end position in the open direction.

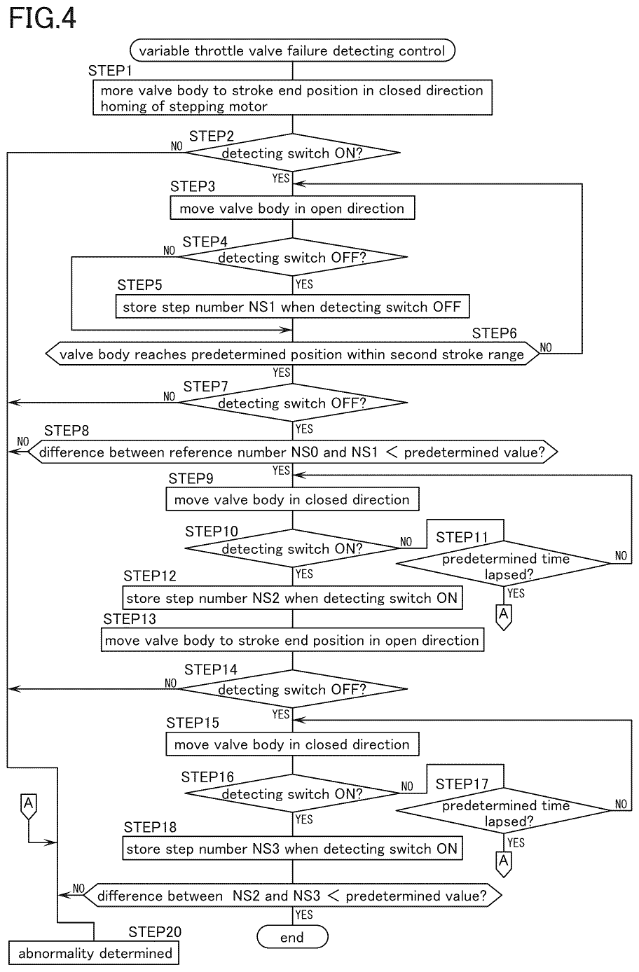

The controller 8 performs a control, as shown in FIGS. 4A, 4B, during out-of-operation in which the fan is not driven—for example, after performing an after-purge by extinguishing the burner 1—in which a failure of the variable throttle valve 74 is detected. In this control, at first, in STEP 1, a first operation is carried out in which the valve body 742 of the variable throttle valve 74 is caused to move to the stroke end position in the closed direction, thereby carrying out homing of the stepping motor 743. Next, in STEP 2, whether the detecting switch 7471 has been turned on or not is determined, and if ON, in STEP 3, a second operation is caused to start in which the valve body 742 is caused to move in the open direction to a predetermined position within the second stroke range. When starting the second operation, in STEP 4, whether the detecting switch 7471 is turned off or not is determined, and if OFF, in STEP 5, a step number NS1 of the stepping motor 743 at the time of switching of the detecting switch 7471 from ON to OFF is stored. Next, in STEP 6, whether the valve body 742 has reached the predetermined position within the second stroke range or not determined based on the step number from the homing position of the stepping motor 743, and if it is determined that the reach has been achieved, the second operation is completed.

After completion of the second operation, in STEP 7, whether the detecting switch 7471 is OFF or not is determined. If OFF, in STEP 8, whether a difference between a reference step number NS0, which is required for the movement from the homing position to the second position, and the aforementioned step number NS1 is less than a predetermined value (for example, 200 steps) is determined. Here, when, during the first operation, the valve body 742 is locked before reaching the stroke end position in the closed direction, homing of the stepping motor 743 is carried out at this locked position. Therefore, during the second operation, the step number NS1 of the stepping motor 743 at the time of the switching of the detecting switch 7471 from ON to OFF becomes a value different from the aforementioned reference number NS0. Accordingly, when the failure occurs in which the valve body 742 is locked at a position some distance before the stroke end position in the closed direction, in STEP 8, “NO” is determined, and, in STEP 20, an abnormality is determined. Therefore, this failure can be detected.

When “YES” is determined in STEP 8, in STEP 9, a third operation is started in which the valve body 742 is caused to move in the closed direction until the detecting switch 7471 switches from OFF to ON. After starting the third operation, in STEP 10, whether the detecting switch 7471 is ON or not is determined. If OFF, in STEP 11, whether a predetermined time (for example, 7 seconds) from the start of the third operation has lapsed or not is determined, and the third operation is continued by returning to STEP 9 until the predetermined time has lapsed. When the detecting switch 7471 is ON, in STEP 12, the step number NS2 of the stepping motor 743 at the time of switching of the detecting switch 7471 from OFF to ON, that is, at the time of completion of the third operation is stored.

Next, in STEP 13, a fourth operation is carried out in which the valve body 742 is caused to move in the open direction to the stroke end position in the open direction. Thereafter, in STEP 14, whether the detecting switch 7471 is OFF or not is determined at the time of completion of the fourth operation. If OFF, in STEP 15, a fifth operation, in which the valve body 742 is caused to move in the closed direction until the detecting switch 7471 switches from OFF to ON, is started. After starting the fifth operation, in STEP 16, the detecting switch 7471 has switched to ON or not is determined. If OFF, in STEP 17, whether a predetermined time from the start of the fifth operation has lapsed or not, and the fifth operation continues until the predetermined time is lapsed by returning to STEP 15. When the detecting switch 7471 switches to ON, in STEP 18, a step number NS 3 of the stepping motor 743 at the time of switching of the detecting switch 7471 from OFF to ON, that is, at the time of completion of the fifth operation is stored.

Next, in STEP 19, a difference between the step number NS2 of the stepping motor 743 at the time of completion of the third operation and the step number NS3 of the stepping motor 743 at the time of completion of the fifth operation is less than a predetermined value is or not is determined. Here, when, during the fourth operation, the valve body 742 is locked before reaching the stroke end position in the open direction, thereafter, although the valve body 742 does not move in the open direction, the step numbers of the stepping motor 743 are accumulated until it is determined by the control logic that the valve body 742 has reached the stroke end position in the open direction and the fourth operation is completed. As a result, the step number NS3 of the stepping motor 743 at the time of completion of the fifth operation becomes larger than the step number NS2 of the stepping motor 743 at the time of completion of the third operation by the step numbers accumulated after the valve body 742 is locked during the fourth operation. Accordingly, when a failure occurs in which the valve body 742 is locked before the stroke end position in the open direction, “NO” is determined in STEP 19, and in STEP 20, an abnormality is determined. Therefore, this failure can be detected.

It should be noted that it may be also considered that the fourth and fifth operations are omitted, and that the third operation is carried out after, the valve body 742 is caused, during the second operation to move to the stroke end position in the open direction, and that, when a difference between the step number of the stepping motor 743 at the time of switching of the detecting switch 741 from OFF to ON during the third operation and a reference step number at the time the valve body 742 reaches the first position is a predetermined value or more, an abnormality is determined. However, since the detecting switch 7471 consisting of the reed switch exhibits a temperature-dependent characteristic, the position at which the detecting switch switches from ON to OFF—i.e., the first position—varies corresponding a temperature. Therefore, in a manner mentioned above in which the fourth and fifth operations are omitted, the following possibility arises. Although no failure occur in which the valve body 742 is locked before reaching the stroke end in the open direction, due to variation in the first position corresponding to temperature, a difference between the step number of the stepping motor 743 at the time of switching of the valve switch 471 from OFF to ON and the reference step number at the time when the valve body reaches the first position becomes the predetermined value or more, and, as a result, an abnormality is erroneously determined. On the contrary, in the embodiment, the step number NS2 of the stepping motor 743 at the time of switching of the detecting switch 7471 from OFF to ON during the third operation is compared with the step number NS3 of the stepping motor 743 at the time of switching of the detecting switch 7471 from OFF to ON during the fifth operation, and it is determined whether an abnormality exists. Therefore, erroneous determination caused by the variation in the first position corresponding to temperature can be prevented. It should be noted that it is desirable that, in order to shorten the time required for the second operation, the predetermined position—i.e., a reaching position of the valve body 742 during the second operation—is set to a position within a range in which the detecting switch 7471 surely switches OFF and as close as possible to the second position.

In addition, when the detecting switch 7471 is OFF at the time of completion of the first operation, and, in STEP 2, “NO” is determined, and also when, even if the third operation and the fifth operation are continued for a predetermined time, the detecting switch 7471 does not switch from OFF to ON, and “Yes” is determined in STEP 11 or STEP 17, an abnormality is determined in STEP 20. Therefore, when a movement failure in the closed direction of the valve body 742 occurs, this failure can be detected. Further, when the detecting switch 7471 has been ON at the time of completion of the second operation and at the time of completion of the fourth operation, and “NO” is determined in STEP 7 or STEP 14, an abnormality is determined in STEP 20. Therefore, when a movement failure in the open direction of the valve body 742 occurs, this failure can be detected.

In the above, the embodiment of the invention has been explained with reference to the figures; however, the invention is not limited to this embodiment. For example, in the embodiment, although the detecting switch 7471 is formed by the reed switch, the detecting switch 7471 may also be formed by a magnetic sensing switch using a Hall element or an MR element, or by a microswitch cooperating with a dog with which the valve body 742 interlocks to cause displacement.

### EXPLANATION OF MARKS

1 Burner
5 Fan
6 Air supply passage
61 Gas suction part
7 Gas supply passage
73 Zero governor
74 Variable throttle valve
742 Valve body
743 Stepping motor
747 Detecting device
7471 Detecting switch
8 Controller (Controlling device)

1. A premixing apparatus that mixes fuel gas with air and supplies an air-fuel mixture to a burner via a fan, comprising:
a zero governor for regulating a secondary gas pressure to atmospheric pressure, the zero governor being interposed in a gas supply passage, of which a downstream end is connected to a gas suction part disposed in a portion of an air supply passage located on an upstream side of the fan;
a variable throttle valve interposed in a portion of the gas supply passage located on a downstream side of the zero governor and driven by a stepping motor; and
a controlling device for controlling the fan and the variable throttle valve,
wherein a detecting device for detecting movements of a valve body of the variable throttle valve is additionally provided with the variable throttle valve, and the detecting device has a detecting switch that turns on when the valve body of the variable throttle valve moves in a closed direction and thereby enters a first stroke range between a predetermined first position and a stroke end position in the closed direction, and turns off when the valve body of the variable throttle valve moves in an open direction and thereby enters a second stroke range between a predetermined second position, which is displaced in the open direction from the first position, and a stroke end position in the open direction,
wherein:
the controlling device is configured to perform a first control in which, during out-of-operation in which the fan is not driven, a first operation and a second operation are carried out sequentially: the first operation in which the valve body is caused to move to the stroke end position in the closed direction, thereby carrying out homing of the stepping motor; and the second operation in which the valve body of the variable throttle valve is caused to move in the open direction to a predetermined position within the second stroke range, and an abnormality is determined when, during the second operation, a step number of the stepping motor at the time of switching of the detecting switch from ON to OFF deviates from a reference step number required for movement from a home position to the second position by a predetermined value or more.

2. The premixing apparatus according to claim 1, wherein the controlling device is configured to perform a second control in which, after the second operation, a third operation, a fourth operation, and a fifth operation are carried out sequentially: the third operation in which the valve body of the variable throttle valve is caused to move in the closed direction until the detecting switch switches from OFF to ON; the fourth operation in which the valve body of the variable throttle valve is caused to move in the open direction until the stroke end position in the open direction; and the fifth operation in which the valve body of the variable throttle valve is caused to move in the closed direction until the detecting switch switches from OFF to ON, and an abnormality is determined when a difference between the step number of the stepping motor at the time of completion of the third operation and the step number of the stepping motor at the time of completion of the fifth operation is a predetermined value or more.

3. The premixing apparatus according to claim 2, wherein the controlling device is configured to perform a third control in which an abnormality is determined when the detecting switch is OFF at completion of the first operation, and when, although at least one of the third operation and the fifth operation is continued for a predetermined time, the detecting switch does not switch from OFF to ON.

4. The premixing apparatus according to claim 2, wherein the controlling device is configured to perform a fourth control in which an abnormality is determined when the detecting device is ON at least at one of the time of completion of the second operation and the time of completion of the fourth operation.

5. The premixing apparatus according to claim 3, wherein the controlling device is configured to perform a fourth control in which an abnormality is determined when the detecting device is ON at least at one of the time of completion of the second operation and the time of completion of the fourth operation.
